(19) United States
(12) Patent Application Publication
(10) Pub. No.: US 2014/0290066 A1
(43) Pub. Date: Oct. 2, 2014

(54) RAZORS AND RAZOR HANDLES

(71) Applicant: EVOSHAVE LIMITED, London (GB)

(72) Inventors: Robert Woolfson, Middlesex (GB); Adam Yaffe, Greater Manchester (GB)

(21) Appl. No.: 14/343,811

(22) PCT Filed: Sep. 5, 2012
(86) PCT No.: PCT/GB2012/052176

§ 371 Date: Jun. 2, 2014

(30) Foreign Application Priority Data
Sep. 8, 2011 (GB) 1115491.1

(51) Int. Cl. B26B 21/52; B26B 21/22

(52) U.S. Cl. CPC B26B 21/527; B26B 21/225; B26B 21/522; B26B 21/521
USPC 30/50; 30/526

(57) ABSTRACT

A razor handle comprising a main body portion and a connector for connecting, in use, the main body portion to a razor cartridge, the main body portion comprising first and second spaced-apart fingertip engaging surfaces adapted, in use, to be engagable with opposite sides of a user's fingertips and a grip portion interposed between the fingertip engaging surfaces. The grip portion is substantially transverse to at least one of the finger engaging surfaces. A first one of the finger engaging surfaces preferably comprises first and second spaced apart fingertip engaging surface portions, one of which fingertip engaging surface portions is located proximally to the connector and most preferably substantially above and behind a trailing edge of the razor cartridge.

This invention relates to razors and razor handles, and in particular, but without limitation to shaving razors and shaving razor handles.

The majority of razors on the market today comprise a handle with an attachment point to which a disposable razor cartridge can be detachably affixed. A user grips the handle to manipulate the razor cartridge and slide it relative to the skin to effect shaving. A conventional razor's handle is normally designed with ergonomics in mind, and thus usually comprises grip portions corresponding to the user's finger positions and high friction components to facilitate gripping the handle when wet.

Shaving razors are available that have been optimised for shaving particular body parts. For example, a generally cylindrical handle that is gripped between the thumb and forefinger of one hand. This type of handle is sometimes considered to be better for shaving a user's face as it can be easily rotated and tilted to obtain the optimum contact angle when shaving the relatively tight curves of a user's face. Conversely, more pad-shaped handles are also available that are considered particularly effective for shaving a user's legs because they afford a large gripping surface. A pad-type configuration affords better control at arm's length, when shaving large areas or when sliding the razor along relatively large distances.

One of the main objectives of shaving is to achieve a close shave, which is best achieved with a sharp blade and when the blade or blades are brought into very close proximity with the skin. These general requirements lead to a risk of cutting the user's skin since the best shaving result is achieved with a very sharp blade brought into almost direct contact with the skin.

To ensure that the blade is kept sharp, many shaving systems make use of disposable razor cartridges which can be detachably affixed to the handle and disposed of when they become blunt. Disposable razor cartridges often comprise a plurality of blades which enable the blades to be set at incrementally closer distances to the user's skin, thereby ensuring a close shave, but reducing the risk of plucking hairs as can happen if the length of the stubble is too long. Moreover, a multi-blade razor cartridge also offers some scope for distributing the pressure applied to the blades over a greater contact area, thereby reducing the risk of cuts and nicks.

Disposable razor cartridges, however, suffer from a number of downsides including being bulky relative to the size of the blades themselves, making it difficult to achieve good control. Moreover, multi-blade razor cartridges, in particular, often require a large contact area with the skin to perform optimally. To alleviate these issues, many disposable razor cartridges are designed to articulate relative to the razor handle so that the cartridge automatically adopts a desired contact angle with respect to the skin and to compensate for incorrect handle angle. Whilst such a setup alleviates some of the problems highlighted above, it can also lead to a general lack of direct control of the razor cartridge and can be clumsy or non-intuitive to use.

This invention aims to address one or more of the above problems and/or to provide an alternative and/or improved razor handle.

According to a first aspect of the invention, there is provided a razor handle comprising a main body portion and a connector for connecting, in use, the main body portion to a razor cartridge, the main body portion comprising first and second spaced-apart finger engaging surfaces adapted, in use, to be engagable with opposite sides of a user's finger and a grip portion interposed between the finger engaging surfaces.

According to a second aspect of the invention, there is provided a razor handle comprising a main body portion and a connector for connecting, in use, the main body portion to a razor cartridge, the main body portion comprising first and second spaced-apart fingertip engaging surfaces adapted, in use, to be engageable with opposite sides of a user's fingertips and a grip portion interposed between the fingertip engaging surfaces.

A third aspect of the invention provides a razor comprising a razor cartridge and a razor handle, the razor cartridge and handle being detachably connectable to one another, wherein the razor handle comprises a main body portion and a connector for connecting, in use, the main body portion to the razor cartridge, the main body portion comprising first and second spaced-apart finger engaging surfaces adapted, in use, to be engagable with opposite sides of a user's finger and a grip portion interposed between the finger engaging surfaces.

A fourth aspect of the invention provides a razor comprising a razor cartridge and a razor handle, the razor cartridge and handle being detachably connectable to one another, wherein the razor handle comprises a main body portion and a connector for connecting, in use, the main body portion to the razor cartridge, the main body portion comprising first and second spaced-apart fingertip engaging surfaces adapted, in use, to be engagable with opposite sides of a user's fingertips and a grip portion interposed between the fingertip engaging surfaces.

The first and second spaced-apart finger engaging surfaces are preferably adapted, in use, to be engageable with opposite sides of a plurality of user's fingers.

The razor cartridge preferably comprises one or more blades having an elongate cutting edge oriented, in use, substantially at right angles to the longitudinal axes of a user's fingers when inserted in, or gripping the handle.

A fifth aspect of the invention provides a razor cartridge for a razor comprising a main body portion having at least two slotted through apertures extending from a front surface thereof to a rear surface thereof, at least one blade located at or towards the front of the cartridge providing two or more cutting edges each cutting edge being aligned with one of the said slotted apertures, and a cover for retaining the blade or blades on the main body portion, wherein the slotted apertures have a cross-section that is wider at or towards the rear of the cartridge than at or towards the front thereof.

One of the main differences between the invention and known razor handles may therefore be that the handle is adapted to grip the user's fingers, rather than the user having to grip the handle. In effect, the razor handle becomes an extension of the user's finger or fingers making it more intuitive and/or natural to use. Moreover, because the handle grips the user's fingers, rather than the user having to grip the handle, this makes the handle particularly useful for users with reduced power or function in their hands, restricted movement or impaired dexterity.

In addition, a conventional razor handle acts as a distance-multiplying/force-reducing lever between the user's hand and the razor cartridge. However, the invention moves the point of interaction between the user's fingers and the razor cartridge much closer together, meaning that a relatively lower force needs to be exerted to achieve a desired blade pressure, which is particularly advantageous for user's with weak hands. In addition, a further effect of bringing the point of interaction between the user's fingers and the razor cartridge closer together is a reduction in distance multiplication, i.e. small movements of the handle do not translate into much larger movements of the razor cartridge. This aspect may be particularly beneficial for users with shaky hands or impaired dexterity.

The first and second finger engaging surfaces are preferably ergonomically shaped to conform to the shape of a user's fingers, and most preferably to the shape of a user's index and second fingers of either hand. By inserting the user's fingers between the finger engaging surfaces, either or both of the finger engaging surfaces can be brought into contact with the fingers to effect gripping thereof.

The grip portion is preferably substantially transverse to at least one of the finger engaging surfaces, i.e. when viewed end-on, the cross-section is substantially I-shaped. The grip portion enables a user to grip the main body portion between the sides or pads of two digits, e.g. the index and second fingers of either hand or the thumb and another finger of either hand.

Accordingly, the razor handle is effectively affixed, in use, to the user's fingers by the finger engaging surfaces gripping opposite sides of one or more fingers, the user gripping the grip portion between two fingers or a thumb and another finger, or any combination of any of the above. In effect, therefore, the razor handle becomes an extension of the user's fingers affording greater control over the position and movement of the razor cartridge. This can be particularly beneficial when shaving body parts at arm's length, e.g. the legs.

Because of the ergonomic shape of the razor handle, it can be used with a variety of hand/finger sizes since one of the finger engaging surfaces is usually only in partial or intermittent contact with the finger.

A first one of the finger engaging surfaces preferably comprises a plurality of finger engaging surface portions. Such a configuration may enable the razor handle to be used in a number of different modes as shall be described in greater detail below. Preferably, at least one of the finger engaging surfaces comprises at least two spaced apart finger engaging surface portions. In a most preferred embodiment of the invention, one of the finger engaging surface portions is located proximally to the connector for the razor cartridge, and most preferably still, substantially above and behind a trailing edge of the razor cartridge. By enabling a user to position the tips of his or her fingers over, on upon, the razor cartridge, a much greater degree of control of the cartridge can be exercised by the finger tips.

A gap or opening in the razor handle is preferably provided adjacent the connector, adjacent the finger engaging surface portion located proximally to the connector, to enable a user's finger or fingers to project beyond a forward periphery of the razor handle to engage the trailing edge of the razor cartridge directly.

Either or both finger engaging surfaces may additionally comprise further finger engaging surface portions at different positions to enable the razor handle to be used in different modes. The plurality of finger engaging surface portions, where provided, may be located, when viewed from the side, at different levels and/or at different distances from the connector.

A resiliently deformable element is preferably disposed on either or both of the finger engaging surfaces and/or on one or both sides of the grip portion. The resiliently deformable element may be adapted, in use, to exert a gripping pressure or force on the user's fingers. The resiliently deformable element, where provided, is preferably manufactured of a high friction material, such as rubber, to facilitate gripping the razor handle when wet or soapy.

The connector preferably comprises relatively moveable engagement projections adapted to engage, in use, complementarily-shaped engagement projections or recesses of the razor cartridge. The engagement projections can be actuatable to move relative to one another by a push button, which could be located anywhere on the razor handle. Most preferably, the push button, where provided, is located on the first finger engaging surface on an opposite side thereof to the finger engaging surface portion, i.e. such that the location of the push button corresponds, in use, to the location of a user's thumb when the first and second digits of a user's hand are inserted between the finger engaging surfaces on opposite sides of the grip portion.

Preferred embodiments of the invention shall now be described, by way of example only, with reference to the accompanying drawings in which:

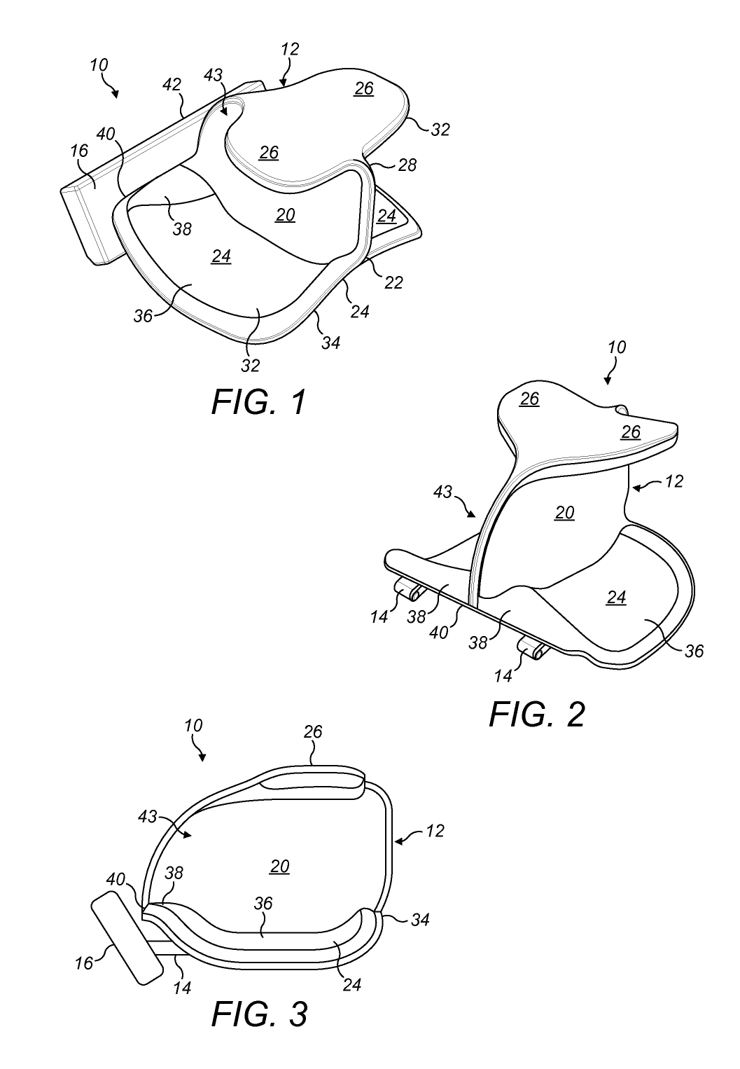

FIG. 1 is a perspective view from above and behind of a shaving razor comprising a first embodiment of a razor handle in accordance with the invention;

FIG. 2 is a perspective view from above and from the front of the shaving razor handle of FIG. 1;

FIG. 3 is a side view of the shaving razor handle of FIG. 1;

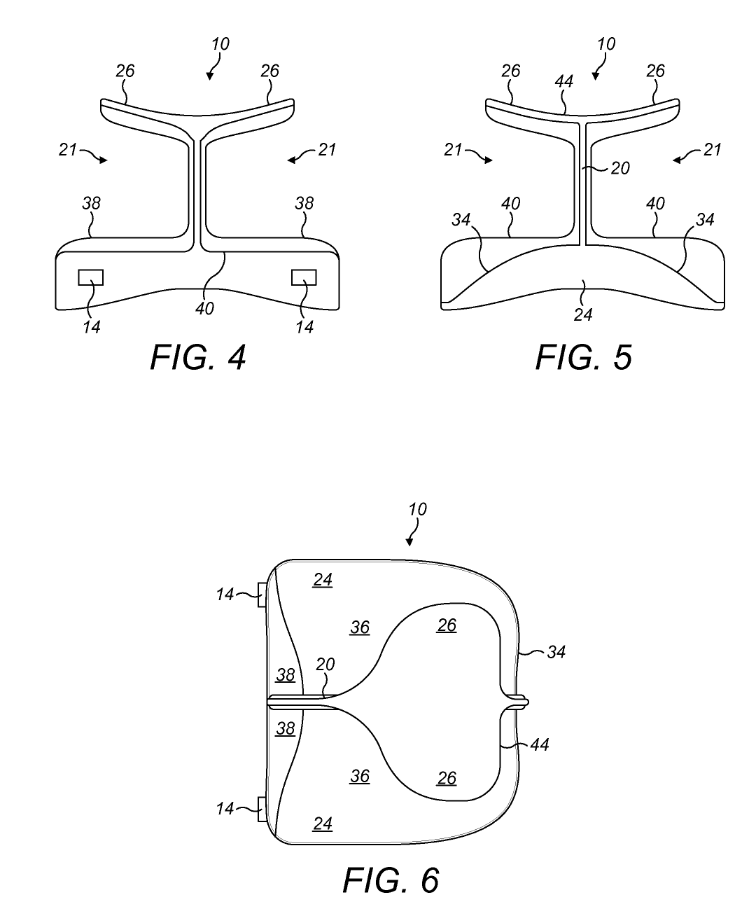

FIG. 4 is an end view from the front of the shaving razor handle of FIG. 1;

FIG. 5 is an end view from the rear of the shaving razor handle of FIG. 1;

FIG. 6 is a plan view from above of the shaving razor handle of FIG. 1;

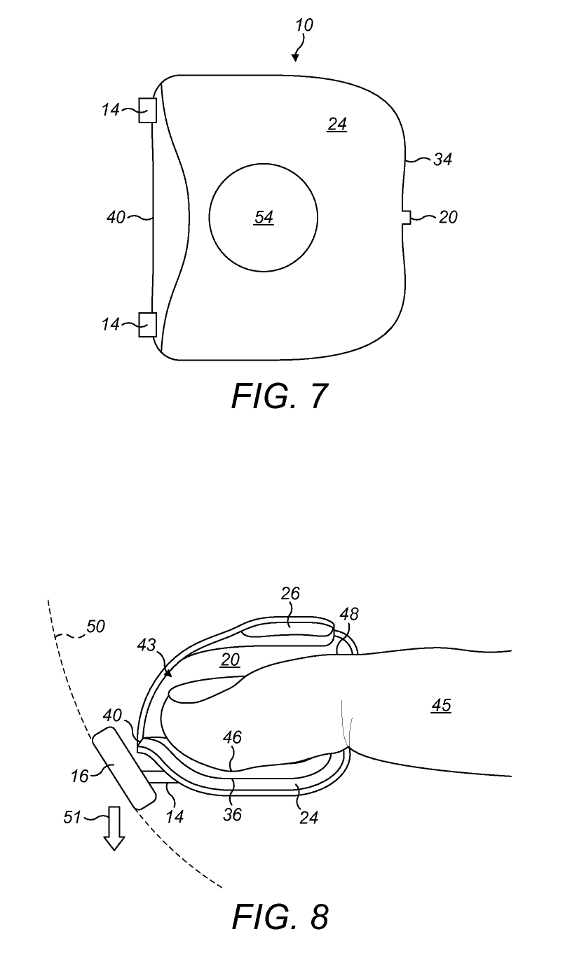

FIG. 7 is a plan view from below of the shaving razor handle of FIG. 1;

FIGS. 8, 9 and 10 are a schematic partial side views of the shaving razor of FIG. 1 being used in modes 1, 2 and 3, respectively;

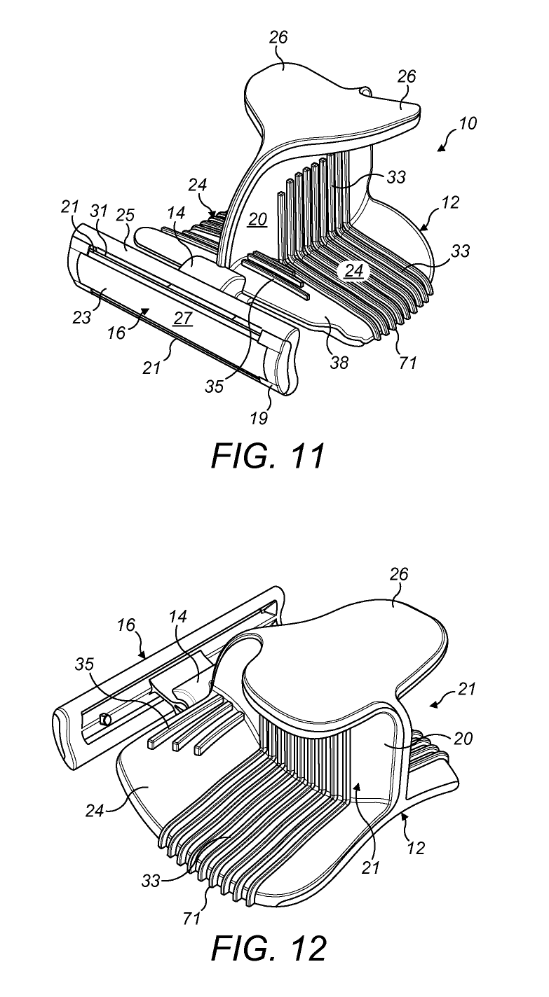

FIG. 11 is perspective view from the front and above of a second embodiment of a razor in accordance with the invention;

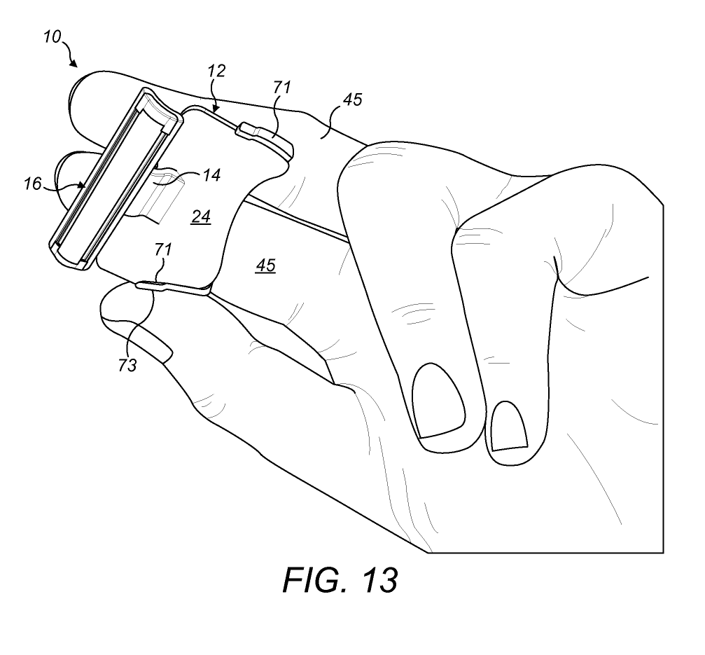

FIG. 12 is a perspective view from above and behind of the razor shown in FIG. 11;

FIG. 13 is a perspective view from below and behind of the razor shown in FIGS. 11 and 12, being gripped by a user;

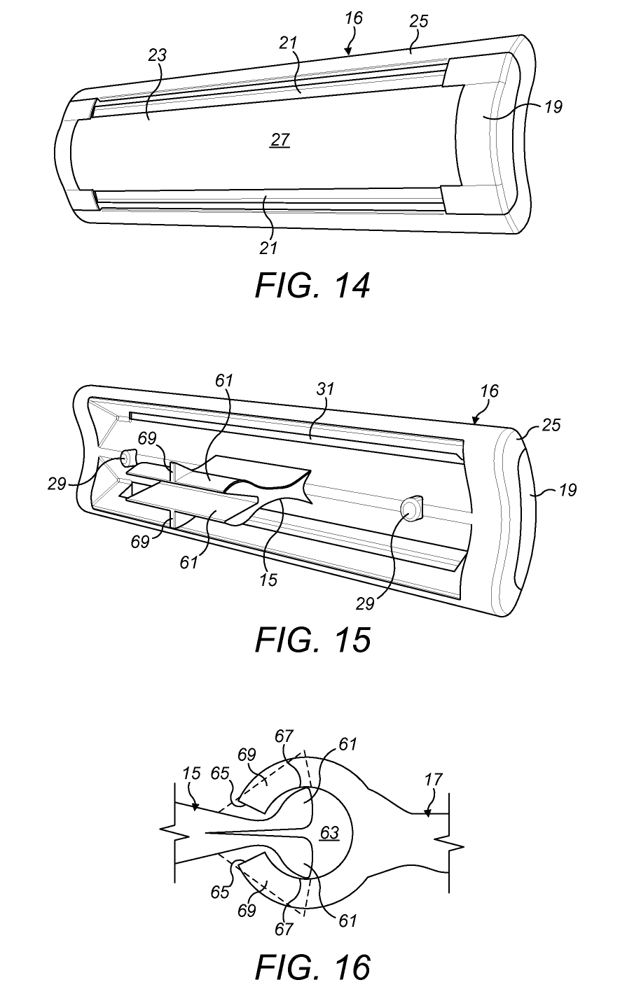

FIG. 14 is a perspective view from the front of the razor cartridge as shown in FIGS. 11 to 13;

FIG. 15 is a perspective view from behind of the razor cartridge of FIG. 14; and

FIG. 16 is a schematic cross-section through the connector of FIGS. 11 to 15.

In FIGS. 1 and 3, a first embodiment of a shaving razor 10 in accordance with the invention comprises a razor handle 12 that is detachably affixable to a disposable razor cartridge 16 by a connector 14. FIGS. 2 and 4 to 7 are additional views of the same razor handle albeit with the razor cartridge removed.

In the following description, directions and orientations referred to (such as up, down, top, front, rear etc.) are internally consistent with the orientation of the handle as shown in the drawings, although it will be appreciated that handle could be rotated about any axis, in which case such references to directions and orientations would need to be interpreted accordingly.

The razor handle of the first embodiment 12 comprises a main body portion having generally planar, central web portion 20 that serves as a grip by which the handle 12 can be gripped, in use, between two digits of a user's hand (not shown). A first edge 22 of the central web portion 20 extends substantially transversely from the centre of a first curved finger engaging surface 24 and a pair of wing portions 26 extend substantially transversely outwardly, in opposite directions, from the opposite edge 28 of the web portion 20.

As is best seen from FIGS. 4 and 5, the main body portion has a generally I-shaped cross-section defining a pair of back-to-back C-shaped recesses 21 for receiving the tips of a user's fingers (not shown). The interior surfaces of the main body portion 18 are provided with a high-friction rubber insert 32, which is formed by a known, two-shot, co-injection moulding process. The rubber insert 32 provides a resiliently deformable/conformable surface that improves the comfort of the razor handle and which reduces slippage relative to the user's fingers (not shown) when wet and/or soapy.

The first curved finger engaging surface 24 is symmetrical about the centreline of the web portion 20 and each side has a rearmost edge 34 that slopes downwardly (as shown in the drawing) from the central web 20. The first finger engaging surface 24 extends forwardly from this edge 34 and dips to form first curved recess 36 that is shaped to conform substantially to the shape of the pad of a user's fingertip before rising to form a raised plateau portion 38 that terminates at a forward edge 40 adjacent the razor cartridge 16. In the illustrated embodiment, the height of the plateau portion 38 corresponds to the height of the trailing edge 42 of the razor cartridge 16 for reasons that are explained below.

The wings 26 too are symmetrical about the centreline of the web portion 20 and each wing has a rearmost edge 44 that slopes upwardly (as shown in the drawing) from the central web 20. The wings 26 extend forwardly from their rear edge 44 and are slightly curved, as best seen in FIG. 4, to conform substantially to the shape of the top of a user's fingertip. It will be noted that the wings 26 terminate a distance back from the razor cartridge 16 to enable the user's fingers (not shown) to project forward, through a gap 43 provided thereby, and onto the trailing edge 42 of the razor cartridge 16, as is best seen in FIG. 4.

In FIG. 7, it can be seen that the razor handle 12 comprises a pair of spaced apart connectors 14 that are resiliently biased to press outwardly away from one another to engage complementarily shaped recesses provided on ribs (not shown) of the disposable razor cartridge 16. The razor cartridge 16 can be clipped into place by a simple pressing action whereby the connectors 14 deform inwardly to click into positive engagement with the ribs of the cartridge 16. When it is desired to replace the cartridge 16, a user can press on a release button 54 provided on the underside of the handle 12 using thumb pressure, the push button 54 being connected to the connectors 14 by an internal lever system (not shown), which causes the connectors 14 to move towards one another thereby disengaging the cartridge 16. Conveniently, the push button 54 is provided at a location that corresponds to that of the user's thumb, in use, enabling a cartridge 16 to be clipped into place and removed by holding the handle 12 with one hand and the cartridge 16 in the other.

The razor handle 12 shown in the drawings can be used in any one of three modes as illustrated schematically in FIGS. 8, 9 and 10.

In FIG. 8, the razor 10 is being used in “mode 1” to shave “with the grain”, in which case the fingers 45 are inserted into the C-shaped recesses 21 such that the pads 46 of the fingertips engage with the first curved recess 36 and such that the wings 26 makes intermittent contact with the back of the finger 48. By bending the fingers 45, the razor cartridge 16 can be moved to inscribe an arcuate path relative to the skin being shaved 50 in a generally downward motion (as shown by arrow 51 in FIG. 8).

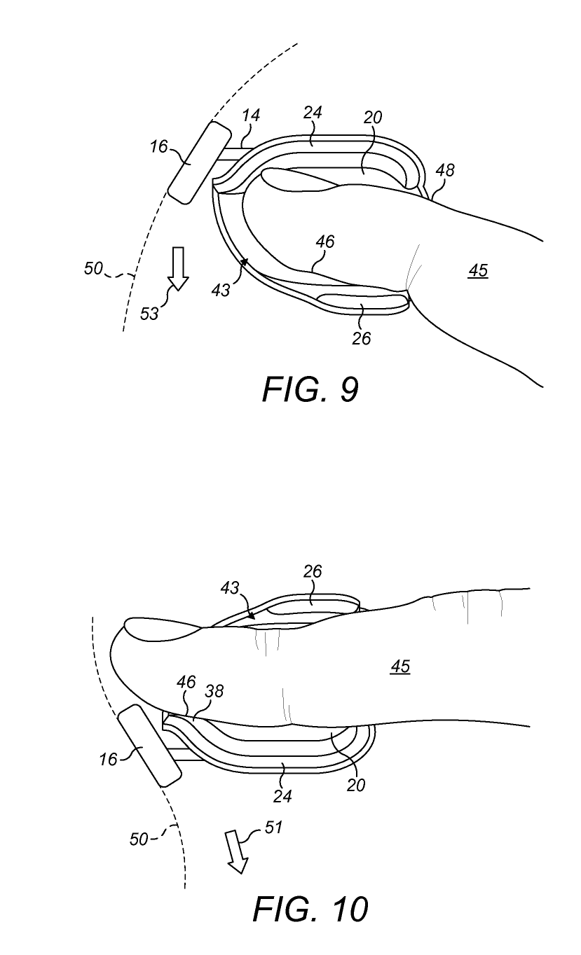

In FIG. 9, the razor 10 is being used in “mode 2” to shave “against the grain”, in which case the fingers 45 are inserted into the C-shaped recesses such that the pads 46 of the fingertips engage with the wings 26 and such that the curved finger engaging surface 24 makes intermittent contact with the back of the finger 48. In this case, by straightening the fingers 45, the razor cartridge can be moved to inscribe an arcuate path relative to the skin being shaved 50 in a generally upward motion (as shown by arrow 53 in FIG. 9).

In situations where a very close shave is required, or where accurate definition is required, e.g. along the edges of a beard, moustache or sideburns, the user can use the razor handle 12 in “mode 3”, as shown in FIG. 10, which is a modification of “mode 1”. In mode 3, the user slides his or her fingers 45 forward on the main body portion 12 such that the pads of his or her fingertips 46 either rest on the raised plateau portion 38, or bridge the raised plateau portion 38 and the trailing edge 42 of the razor cartridge 16. Mode 3 provides a more direct connection between the user's fingers 45 and the razor cartridge 16 enabling detailed or very close shaving to be effected.

FIGS. 11 to 15 show a second embodiment of a razor in accordance with the invention. For the sake of clarity, identical reference signs have been used in relation to FIGS. 11 to 15 to identify identical features to those previously described in relation to FIGS. 1 to 10.

In FIGS. 11 to 15 the second embodiment of a shaving razor 10 in accordance with the invention comprises a razor handle 12 that is detachably affixable to a disposable razor cartridge 16 by a connector 14. The razor handle 12 of the second embodiment comprises a main body portion having generally planar, central web portion 20 that serves as a grip by which the handle 12 can be gripped, in use, between two digits of a user's hand (not shown). A first edge 22 of the central web portion 20 extends substantially transversely from the centre of a first curved finger engaging surface 24 and a pair of wing portions 26 extend substantially transversely outwardly, in opposite directions, from the opposite edge 28 of the web portion 20.

As is best seen in FIG. 12, the main body portion 12 has a generally I-shaped cross-section defining a pair of back-to-back C-shaped recesses 21 for receiving the tips of a user's fingers (not shown). The interior surfaces of the main body portion 18 are provided with a high-friction rubber insert 32, which is formed by a two-shot, co-injection moulding process. The rubber insert 32 provides a resiliently deformable/conformable surface that improves the comfort of the razor handle and which reduces slippage relative to the user's fingers (not shown) when wet and/or soapy. To facilitate this, the rubber insert 32 comprises a number of sets of substantially parallel ribs 33 that project from its surface. It will also be noted, from FIG. 13 in particular, that the rubber insert 32 and the ribs are formed so as to wrap around the edges of the lower fingertip engaging surfaces so as to provide, in use, thumb grips 71 for a user's thumb pad 73, which facilitates gripping and manipulating the razor 10, in use.

The first curved finger engaging surface 24 is symmetrical about the centreline of the web portion 20 and each side has a rearmost edge 34 that slopes downwardly (as shown in the drawing) from the central web 20. The first finger engaging surface 24 extends forwardly from this edge 34 and dips to form first curved recess that is shaped to conform substantially to the shape of the pad of a user's fingertip before rising to form a raised plateau portion 38 that terminates at a forward edge 40 adjacent the razor cartridge 16. In the illustrated embodiment, the height of the plateau portion 38 corresponds to the height of the trailing edge 42 of the razor cartridge 16 for reasons that are explained below. The plateau portion 38 is also provided with a set of transverse ribs 35 formed in the high-friction rubber insert to reduce relative slippage of the razor handle 12 and a user's fingertips, in use.

The wings 26 too are symmetrical about the centreline of the web portion 20 and each wing has a rearmost edge 44 that slopes upwardly (as shown in the drawing) from the central web 20. The wings 26 extend forwardly from their rear edge 44 and are slightly curved, as best seen in FIG. 12, to conform substantially to the shape of the top of a user's fingertip. It will be noted that the wings 26 terminate a distance back from the razor cartridge 16 to enable the user's fingers (not shown) to project forward, through a gap 43 provided thereby, and onto the trailing edge 42 of the razor cartridge 16.

The razor cartridge 16 is connected to the handle 12 by a connector 14 that comprises a male part 15 projecting rearward from the back of the cartridge, which engages a female part 17 projecting forward from the leading edge of the razor handle 12. As can be seen best in FIGS. 13, 15 and 16, the male part 15 comprises a plastics projection that is integrally formed with the main body 19 of the razor cartridge 16. The male projection comprises a bifurcated end that enables the two vertically splayed tines 61 of the projection 15 to resiliently deform towards each other as they are pushed into the female connector part 17. The female connector part 17 comprises a generally C-shaped receiving recess 63 for the male part 15 that positively engages it as the two parts are push-fitted, or snapped together. The generally C-shaped receiving recess has a tapered entrance 65 to guide the bifurcated ends 61 of the male part 15 towards each other as the cartridge 16 is snapped into position, leading to a wider part 67 into which the bifurcated ends 61 of the male part 15 can expand to retain the cartridge 16 in position. The female part 17 is also manufactured as an integral part of the main body portion of the razor handle 12.

The bifurcated ends 61 of the male part 15 additionally comprises a pair of vertical projections 69 that engage with slots of the female part 15 of the connector 14 to inhibit or prevent relative lateral slippage of the razor cartridge 16 and the handle 12, and to restrict the movement of the cartridge 16 relative to the handle 12. The amount of relative movement permitted can be determined by the appropriate selection of clearances between the various parts of the male and female parts of the connector 14.

The provision of a bifurcated end to one of the connector parts gives rise to two effects: firstly, the cartridge is able to positively snap into engagement with the handle as the splayed tines of the bifurcated end are deformed to fit into the receiving recess of the female part; and secondly, the deformation of the tines allows the cartridge to pivot relative to the handle, but to spring back to a central position when the pivoting force is removed by the action of the tines pressing outwardly on the C-shaped receiving recess.

The main body portion of the razor handle 12 and the main body portion 19 of the cartridge 16 are both manufactured from injection moulded polypropylene, which is a resiliently deformable material. As such, the connection 14 between the handle 12 and cartridge 16 is able to flex in different directions, thus permitting a limited amount of relative movement, in use, between the handle 12 and the cartridge. Such a configuration enables the orientation of the cartridge 16 to conform to the plane of the shaving action, thus ensuring good contact between the blades 21 of the cartridge 16 and the roots of the hairs being shaved.

It will be noted that the construction of the connection between the cartridge 16 and the handle 12 of the second embodiment of the invention is simpler that that shown in relation to the first embodiment. By integrally forming the male and female connector parts from a resiliently deformable material with the main body portions of the handle and cartridge, it is possible to obtain a detachable, articulated interconnection without the need for moving parts, which greatly simplifies the manufacture of the razor 10, reduces the likelihood of failure, and renders the razor easier to use.

Alternative embodiments of the invention, such as that described in relation to FIGS. 1 to 10 above, make use of an articulated connection between the handle 12 and the cartridge 16 to obtain the same, or a similar effect. Most preferably, the amount of relative movement is restricted, either by end-stops or by the resilience of the components, such that the cartridge 16 is restrained, to a desired extent, against moving freely relative to the handle 12.

The cartridge 16 of the razor 10 is shown in detail in FIGS. 14 and 15, from which it can be seen that the cartridge 16 is made up from four parts, namely a main body portion 19, a pair of strip blades 21 and a cover 23. The main body portion 19 is provided with a rubberised coating 25 which serves to cushion the cartridge 16 as it slides, in use, over a user's face. The blades 21 are held in place by the cover 23, which comprises a curved face portion 27 that enables the cartridge 16 to be oriented against the user's skin at a desired angle, and a pair of limb portions 29 that extend through apertures in the main body portion 19 to clamp the blades 21 to the main body portion 19. The ends of the limbs 29 are spot-welded or melted to prevent the cover 23 from separating from the main body portion 19.

As can be seen from FIG. 14 in particular, the rear of the main body portion of the cartridge 16 comprises a pair of slotted apertures 31 whose positions correspond to the leading edges of the blades on the front of the cartridge 16. In a known razor cartridge, this slot is parallel-sided and/or partially obstructed by cross members, which can lead to blockage of the slot by hairs during shaving. However, in the invention, the slotted apertures 31 are significantly more open, providing a clear path for water flowing through and around the cartridge, to enable the hairs to be flushed away more easily. As shown in FIG. 14 in particular, the slotted apertures 31 have a generally V-shaped cross-section to facilitate flushing cut hairs from the cartridge using water. It will also be noted that the embodiment shown has no cross-members partially obstructing the slotted apertures 31 and that the cartridge 16 is spaced apart from the handle 12 by the connector 14, thus greatly facilitating cleaning of the cartridge 16, in use.

The second embodiment of the razor can be used in any of the three modes described above. The blades 21 of the cartridge 16 are oriented to face in opposite directions such that a user can operate the razor 10 against the grain without having to invert the handle (as shown in FIG. 9) and re-insert his or her fingers into the handle.

Notably, the overall shape of the main body portion 12 is designed to be ergonomic and intuitive to use, that is, it is designed to be immediately apparent from visual inspection how the handle 12 should be used. Moreover, because the user has greater and more direct control over the position and movement of the razor cartridge, the connector 16 does not necessarily need to provide an articulated connection between the handle 12 and razor cartridge 16, which simplifies its construction.

The handle 12 is preferably manufactured from a durable, lightweight plastics material, such as acrylonitrile-butadiene styrene (ABS), polyethylene (PE), polypropylene (PP), although other materials, including metals, composites etc. may be used to good effect. Advantages of the handle's relative small size and lightweight construction include: that its weight can be reduced compared to a conventional razor handle making it feel “weightless” in use; reduced volume meaning it's easier to store and transport; and a general reduction in material use and/or cost in its manufacture and/or disposal at the end of its life.

The invention is not restricted to the specifics of the foregoing embodiment, which is merely exemplary. For example, the shape, dimensions and configuration of the handle, the mode of connecting the blades/razor cartridge to the handle, the position of the push button, the materials of manufacture, etc., could be changed without departing from the invention.

1. A razor handle, comprising:
a main body portion; and
a connector which, in use, connects the main body portion to a razor cartridge,
the main body portion comprising spaced-apart first and second finger engaging surfaces which, in use, are engageable with opposite sides of a user's fingers, and a grip portion interposed between the first and second finger engaging surfaces.

2-3. (canceled)

4. The razor handle of claim 1, wherein the first and second finger engaging surfaces are engageable with opposite sides of a plurality of the user's fingers.

5. The razor handle of claim 1, wherein the grip portion is substantially transverse to at least one of the first and second finger engaging surfaces.

6. The razor handle of claim 1, wherein the first finger engaging surface comprises first and second spaced apart finger engaging surface portions.

7. The razor handle of claim 6, wherein the first finger engaging surface portion is located proximate the connector.

8. The razor handle of claim 6, wherein the first finger engaging surface portion is located substantially above and behind a trailing edge of the razor cartridge.

9. The razor handle of claim 6, wherein the first and second finger engaging surface portions are located, when viewed from a side, at different levels.

10. The razor handle of claim 1, further comprising at least one of a gap and an opening in the razor handle adjacent the connector.

11. The razor handle of claim 10, wherein the at least one of the gap and the opening enables, in use, at least one of the user's fingers to project beyond a forward periphery of the razor handle.

12. The razor handle of claim 1, further comprising a resiliently deformable element disposed on at least one of the first and second finger engaging surfaces.

13. The razor handle of claim 12, wherein the resiliently deformable element is manufactured of a high friction material.

14. The razor handle of claim 12, wherein the resiliently deformable element extends around an edge of at least one of the first and second finger engaging surfaces thereby forms a thumb grip on an edge of the handle.

15. The razor handle of claim 12, wherein the resiliently deformable element comprises at least one set of projections which form grip surfaces.

16. The razor handle of claim 1, wherein the connector comprises relatively moveable engagement projections which engage, in use, at least one of complementarily-shaped engagement projections and recesses of the razor cartridge.

17. The razor handle of claim 16, wherein the engagement projections move relative to one another in response to depression of a push button.

18. The razor handle of claim 17, wherein the push button is located on the first finger engaging surface on a side thereof opposite to a finger engaging surface portion.

19. The razor handle of claim 18, wherein a location of the push button corresponds, in use, to a location of a user's thumb when first and second digits of a user's hand are inserted between the first and second finger engaging surfaces on opposite sides of the grip portion.

20. The razor handle of claim 1, wherein the connector comprises a male part comprising a bifurcated end which positively engages with a generally C-shaped receiving recess of a female part.

21. The razor handle of claim 20, wherein the C-shaped receiving recess comprises a tapered entrance which guides the bifurcated ends of the male part towards each other as the male part is snapped into the female part, the tapered entrance leading to a wider part into which the bifurcated ends of the male part can expand to retain the male and female parts in situ.

22. The razor handle of claim 21, wherein the bifurcated ends of the male part additionally comprise a vertical projection which engages with a slot of the female part of the connector.

23. The razor handle of claim 20, wherein at least one of the male and female parts is integrally formed with at least one of the handle and the razor cartridge.

24. The razor handle of claim 23, wherein either or both at least one of the male and female parts is integrally formed with a resiliently deformable part of at least one of the handle and the razor cartridge.

25. A razor cartridge for a razor, the razor cartridge comprising:
a main body portion having at least two slotted through apertures extending from a front surface thereof to a rear surface thereof, the slotted apertures having a cross-section that is wider proximate a rear of the cartridge than proximate a front of the cartridge;
at least one blade located proximate the front of the cartridge and having at least two cutting edges, each cutting edge being aligned with a respective one of the apertures; and
a cover which retains the blade on the main body portion.

26. The razor cartridge of claim 25, wherein the at least one blade comprises at least two blades, the blades facing in substantially opposite directions.

27. The razor cartridge of claim 25, further comprising a rubberized coating disposed on at least part of the main body portion.

28. The razor cartridge of claim 25, further comprising a curved face portion.

29-30. (canceled)

31. The razor handle of claim 10, wherein the at least one of the gap and the opening enables, in use, at least one of the user's fingers to engage a trailing edge of the razor cartridge.

32. The razor handle of claim 1, further comprising a resiliently deformable element disposed on at least one of opposing sides of the grip portion.

33. A razor, comprising:
a razor cartridge; and
a razor handle including:
a) a main body portion comprising spaced-apart first and second finger engaging surfaces which, in use, are engageable with opposite sides of a user's fingers, and a grip portion interposed between the first and second finger engaging surfaces, and
b) a connector which, in use, connects the main body portion to a razor cartridge.

34. The razor of claim 33, wherein the razor cartridge and the handle are detachably connectable to each other.

35. The razor of claim 34, wherein the razor cartridge comprises at least one blade having an elongate cutting edge oriented, in use, substantially at right angles to longitudinal axes of the user's fingers when the user's fingers are at least one of inserted in and gripping the handle.

36. The razor of claim 33, wherein the first and second finger engaging surfaces are engageable with opposite sides of a plurality of the user's fingers.

37. The razor of claim 33, wherein the grip portion is substantially transverse to at least one of the first and second finger engaging surfaces.

38. The razor of claim 33, wherein the first finger engaging surface comprises first and second spaced apart finger engaging surface portions.

39. The razor of claim 38, wherein the first finger engaging surface portion is located proximate the connector.

40. The razor of claim 38, wherein the first finger engaging surface portion is located substantially above and behind a trailing edge of the razor cartridge.

41. The razor of claim 38, wherein the first and second finger engaging surface portions are located, when viewed from a side, at different levels.

42. The razor of claim 33, further comprising at least one of a gap and an opening in the razor handle adjacent the connector.

43. The razor of claim 42, wherein the at least one of the gap and the opening enables, in use, at least one of the user's fingers to engage a trailing edge of the razor cartridge.

44. The razor of claim 42, wherein the at least one of the gap and the opening enables, in use, at least one of the user's fingers to project beyond a forward periphery of the razor handle.

45. The razor of claim 33, further comprising a resiliently deformable element disposed on at least one of the first and second finger engaging surfaces.

46. The razor of claim 45, wherein the resiliently deformable element is manufactured of a high friction material.

47. The razor of claim 45, wherein the resiliently deformable element extends around an edge of at least one of the first and second finger engaging surfaces and thereby forms a thumb grip on an edge of the handle.

48. The razor of claim 45, wherein the resiliently deformable element comprises at least one set of projections which form grip surfaces.

49. The razor of claim 33, wherein the connector comprises relatively moveable engagement projections which engage, in use, at least one of complementarily-shaped engagement projections and recesses of the razor cartridge.

50. The razor of claim 49, wherein the engagement projections move relative to one another in response to depression of a push button.

51. The razor of claim 50, wherein the push button is located on the first finger engaging surface on a side thereof opposite to a finger engaging surface portion.

52. The razor of claim 51, wherein a location of the push button corresponds, in use, to a location of a user's thumb when first and second digits of a user's hand are inserted between the first and second finger engaging surfaces on opposite sides of the grip portion.

53. The razor of claim 33, wherein the connector comprises a male part comprising a bifurcated end which positively engages with a generally C-shaped receiving recess of a female part.

54. The razor of claim 53, wherein the C-shaped receiving recess comprises a tapered entrance which guides the bifurcated ends of the male part towards each other as the male part is snapped into the female part, the tapered entrance leading to a wider part into which the bifurcated ends of the male part can expand to retain the male and female parts in situ.

55. The razor of claim 54, wherein the bifurcated ends of the male part additionally comprise a vertical projection which engages with a slot of the female part of the connector.

56. The razor of claim 53, wherein at least one of the male and female parts is integrally formed with at least one of the handle and the razor cartridge.

57. The razor of claim 56, wherein either or both at least one of the male and female parts is integrally formed with a resiliently deformable part of at least one of the handle and the razor cartridge.

58. The razor of claim 33, further comprising a resiliently deformable element disposed on at least one of opposing sides of the grip portion.

59. The razor of claim 33, wherein the razor cartridge comprises:
a main body having at least two slotted through apertures extending from a front surface thereof to a rear surface thereof, the slotted apertures having a cross-section that is wider proximate a rear of the cartridge than proximate a front of the cartridge;
at least one blade located proximate the front of the cartridge and having at least two cutting edges, each cutting edge being aligned with a respective one of the apertures; and
a cover which retains the blade on the main body.
